(19) United States
(12) Patent Application Publication
(10) Pub. No.: US 2004/0032985 A1
(43) Pub. Date: Feb. 19, 2004

(54) Edge image acquisition apparatus capable of accurately extracting an edge of a moving object

(75) Inventor: Youichi Kawakami, Tondabayashi-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/614,847

(22) Filed: Jul. 8, 2003

(30) Foreign Application Priority Data
Jul. 12, 2002 (JP) 2002-203708(P)

(51) Int. Cl. G06K 9/48; G06K 9/00; G06K 9/36

(52) U.S. Cl. 382/199; 382/107; 382/281

(57) ABSTRACT

An edge image acquisition apparatus obtains an image of a time (t−Δt) and an image of time t, i.e., images different in time by Δt. The apparatus calculates their motion difference to produce a motion difference image. Furthermore the apparatus calculates a spatial difference of one of the images to produce a spatial difference image. The produced motion and spatial difference images are then logically ANDed together to produce a logically ANDed image to extract and output an edge.

This application is based on Japanese Patent Application No. 2002-203708 filed with Japan Patent Office on Jul. 12, 2002, the entire content of which is hereby incorporated by reference.

### BACKGROUND OF THE INVENTION

1. Field of the Invention

The present invention relates generally to edge image acquisition apparatuses, edge image acquisition methods and program products, and particularly to edge image acquisition apparatuses, edge image acquisition methods and program products capable of accurately extracting an edge of a moving object.

2. Description of the Related Art

In recent years there is an increasing demand for a monitoring camera employing image recognition technology that for example detects trespassers, tracks trespassers and informs the user of their existence. For such a monitoring camera, detecting that a trespasser exists is important.

As one such method of detecting a trespasser, a motion region is detected in a motion image. Simply detecting a motion region, however, also detects a non-human moving object, for example a tree branch swayed by the wind, a window curtain, vehicles and the like, resulting in increased erroneous detections.

As one method of detecting a human existence, a human head is detected. A human head has an oval geometry with an edge independently of the head's direction. It can thus be expected to be constantly oval. Accordingly by extracting an oval edge from an image a human head can be detected. More specifically, extracting an oval edge in a motion region prevents erroneous detection of a non-human moving object as a trespasser.

Thus extracting an edge often involves using a differential image obtained by obtaining a spatial or motion difference of obtained images. For example, U.S. Pat. No. 5,881,171 discloses a method of extracting a region of a particular geometry that obtains a spatial difference of obtained images to prepare a single differential image and uses this spatial difference to extract an edge which is in turn traced to detect an edge of a target geometry.

U.S. Patent Publication No. 2001/0002932 discloses a face extraction method using one of a spatial difference and a motion difference to prepare a single differential image which is in turn used to extract an edge.

As described in U.S. Pat. No. 5,881,171 or U.S. Patent Publication No. 2001/0002932, however, when only a single spatial difference image is used to extract an edge, a still object's edge would also be detected. This disadvantageously results in an increased amount of edge and hence an increased processing time. Furthermore, an edge having a geometry similar to that to be detected may often be erroneously detected.

Furthermore, as disclosed in U.S. Patent Publication No. 2001/0002932, when only a single motion difference image is used to extract an edge of a single object moving at a speed two edges are disadvantageously detected for the single object.

### SUMMARY OF THE INVENTION

One object of the present invention is therefore to provide an edge image acquisition apparatus, edge image acquisition method and program product capable of accurately extracting an edge of a moving object.

The above object of the present invention is achieved by the apparatus including: an image capturing unit capturing an image of an object, the image capturing unit capturing a first image and a second image at a time different than the first image, the second image having a background identical to that of the first image; and a controller exerting control to obtain a first differential image based on the first image and a second differential image based on at least one image including the second image and perform an operation on the first and second differential images to produce an edge image of a moving object.

In accordance with the present invention in another aspect the method of obtaining an edge image of a moving object includes the steps of: capturing an image of an object, the image including a first image and a second image having a background identical to that of the first image and captured at a time different than the first image; obtaining a first differential image based on the first image and a second differential image based on at least one image including the second image; and performing an operation on the first and second differential images to produce an edge image of a moving object.

In accordance with the present invention in still another aspect the program product is a computer readable program product causing a computer to obtain an edge image of a moving object, the product causing the computer to execute the steps of: capturing an image of an object, the image including a first image and a second image having a background identical to that of the first image and captured at a time different than the first image; obtaining a first differential image based on the first image and a second differential image based on at least one image including the second image; and performing an operation on the first and second differential images to produce an edge image of a moving object.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of a monitoring system in an embodiment.

FIG. 2 is a flow chart representing a process executed in the monitoring system.

FIG. 3 is a flow chart representing a head detection process effected at step S202.

FIG. 4 is a flow chart for illustrating a vote operation effected at step S303.

FIG. 5 is a flow chart for illustrating an edge image production effected at step S401.

FIG. 6 is a block diagram showing a flow of a process in the monitoring system of an embodiment.

FIGS. 7A and 7B show a specific example of images input to the monitoring system.

FIG. 8 shows a binarized motion difference image of two images input to the monitoring system.

FIG. 9 shows an image obtained by binarizing a spatial difference image obtained by applying a Sobe1 operator to an image input to the monitoring system.

FIG. 10 shows a logically ANDed image obtained by logically ANDing together the images as shown in FIGS. 8 and 9.

FIGS. 11-13 are each a block diagram showing a flow of a process in the monitoring system of an embodiment.

### DESCRIPTION OF THE PREFERRED EMBODIMENTS

Hereinafter with reference to the drawings the present invention in an embodiment will be described. In the following description, like components are identically denoted. Such components are also identical in name and function.

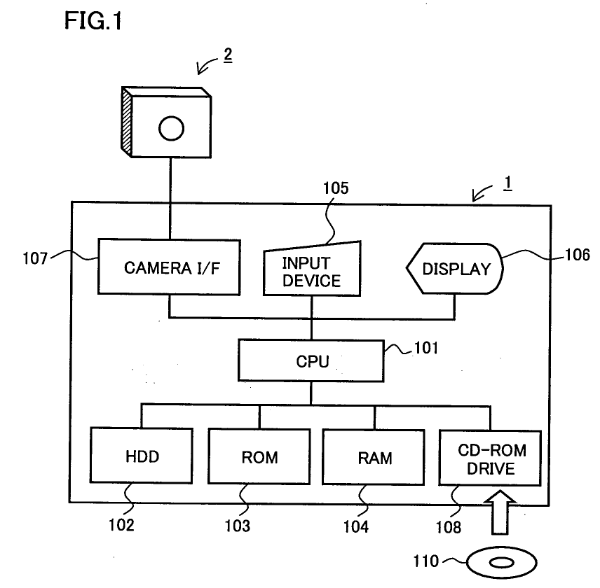

FIG. 1 shows a specific example of a configuration of a monitoring system in the present embodiment. With reference to the figure, the monitoring system includes a computer (PC) 1 such as a personal computer, having an image processing function, and a camera 2 provided in the form of an image capturing device capturing a motion image.

Furthermore, with reference to FIG. 1, PC 1 is controlled by central processing unit (CPU) 101 to process a motion image received from camera 2 through a camera interface (I/F) 107 (also referred to as an image capture portion). CPU 101 executes a program stored in a storage corresponding to a hard disc drive (HDD) 102 or a read only memory (ROM) 103. Alternatively the CPU 101 may execute a program recorded in a compact disc-ROM (CD-ROM) 110 or a similar recording medium and read via a CD-ROM drive 108. A random access memory (RAM) 104 serves as a temporary working memory when CPU 101 executes the program. The user uses a keyboard, a mouth or a similar input device 105 to input information, instructions and the like. A motion image received from camera 2, a result of processing the image, and the like are displayed on a display 106. Note that the FIG. 1 configuration is that of a typical personal computer and the configuration of PC 1 is not limited to the FIG. 1 configuration. Furthermore, camera 2 is a typical device having a means obtaining and inputting a motion image to PC 1 and it may be a video device or a similar device.

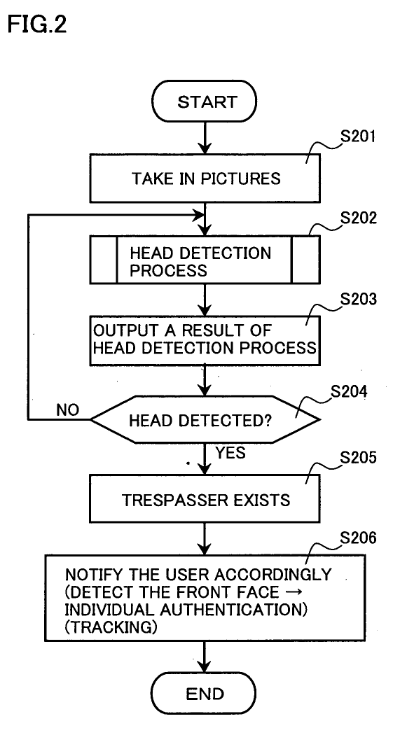

In such a monitoring system as described above a process is effected to monitor a suspected trespasser, as follows: FIG. 2 is a flow chart representing a process performed in the monitoring system, implemented by the PC 1 CPU 101 reading a program stored in HDD 102 or ROM 103, and executing the program on RAM 104.

With reference to FIG. 2, CPU 101 takes in two images from chronologically arranged images obtained from camera 2 through camera I/F 107 (S201). The two images are different in time. While appropriately, the two images are taken in with a temporal interval of several hundreds milliseconds to several seconds, the images may be taken in with a different temporal interval. Furthermore, if an image of a background alone can be obtained, one of the two images may be obtained as a background image of a background alone.

CPU 101 then detects a head portion in the two obtained images (S202). The S202 head detection process will later be described more specifically with reference to a subroutine. A result of the head detection process is output (S203). If no head portion is detected (No at S204) then the two images have a different portion subjected to the head detection process. If a head portion is detected (Yes at S204) a decision is made that there exists a trespasser (S205) and a process notifying the user accordingly is performed (S206). Furthermore, at step S206, other than the notification process there may be performed a process finding the trespasser's face from an obtained image for individual authentication, a process tracking a trespasser and capturing an image thereof, or a similar process.

Thus the process in the monitoring system in the present embodiment ends.

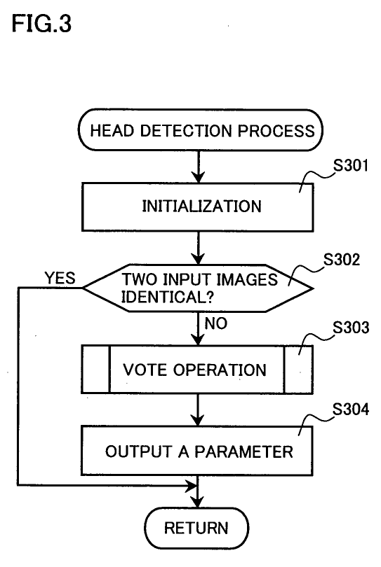

The S202 head detection process will be described with reference to FIG. 3. Initially an initialization process is effected (S301) to clear a vote value of the entirety of a vote space. A vote operation will be described later. A decision is made as to whether two obtained images are equal (S302). At step S302, gray scale images (images represented in non-colored gray) are compared and whether two images are equal or not is determined. To do so, CPU101 converts the obtained images to gray scale images, as required, before the CPU 101 performs the head detection process.

If at step S302 the two images are equal (Yes at S302) a decision is made that there does not exist a moving object and the head detection process ends. Otherwise (No at S302) a vote operation is performed (S303) and in accordance with a vote value thereof a parameter described hereinafter is obtained and output (S304).

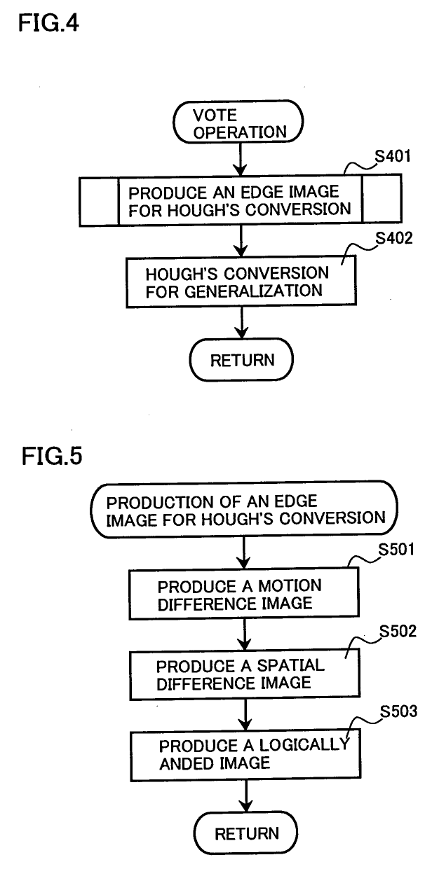

The head detection process thus ends and the control returns to the FIG. 2 main routine. The S303 vote operation will be described with reference to the FIG. 4 flow chart. With reference to the figure, the vote operation is effected by Hough's conversion for generalization. CPU 101 produces a binarized edge image from the two obtained gray scale images for Hough's conversion (S401) and in accordance with the edge image Hough's conversion for generalization is performed (S402). In doing so, a head portion to be detected may be changed in size, while the S401 and S402 steps may be performed repeatedly.

Thus the vote operation ends and the control returns to the FIG. 3 subroutine.

The S401 edge image production will be described with reference to FIG. 5. With reference to the figure, CPU 101 calculates a difference of two images different in time (a data difference for each image). The result is binarized using a predetermined threshold value to produce a motion difference image (S501).

Furthermore, one of the two read images is used to calculate a spatial difference. The calculation's result is binarized using a predetermined threshold value to produce a spatial difference image (S502). At step S502, either one of the two read images may be used to calculate a spatial difference. To obtain the latest position of a moving object, however, using an image later in time to produce a spatial difference image is desirable. Since a spatial difference image is only required to be an image extracting a contour of an object, it may be an image produced by using the Sobe1 operator, the Canny operator or a similar operator (filter).

The motion difference image and the spatial difference image are then logically ANDed together by CPU 101 to form a logically ANDed image (S503). In other words, at step S503 a binarized edge image is produced.

An edge image production process thus ends and the control returns to the FIG. 4 subroutine. Note that while in the above description at steps S501 and S502 binarized differential images are produced and at step S503 a logically ANDed image is formed, at steps S501 and S502 differential image may not be binarized.

In FIG. 3 at step S303 a vote operation at Hough's conversion as described above is performed and at step S304, from a vote value, or a logically ANDed image, a candidate head region's parameters (a head's center coordinate and radius) are obtained and output. In other words, a position of an edge of a moving object is extracted and output. A parameter can be obtained from a vote value for example by initially outputting a vote result (a logically ANDed image) having the largest vote value followed by those having smaller vote values, clustering a vote result, or the like.

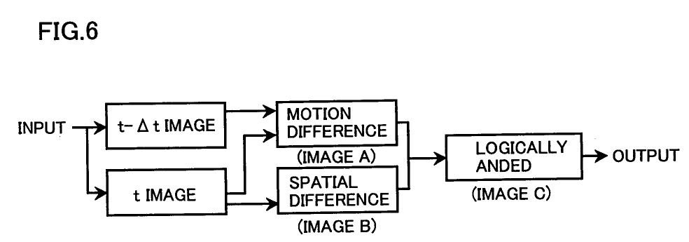

In the present embodiment the monitoring system allows a moving object to be extracted, as described above, through a process having a flow as shown in the block diagram of FIG. 6. More specifically, in the monitoring system, images different in time by Δt, i.e., an image of a time (t−Δt) and an image of a time t are obtained. Their motion difference is then calculated to produce a motion difference image (an image A). Furthermore, a spatial difference of one of the images (the image of time t in FIG. 6) is calculated to produce a spatial difference image (an image B). The images A and B are logically ANDed together, thereby an edge is extracted to be output.

The above process flow will more specifically be described with reference to images.

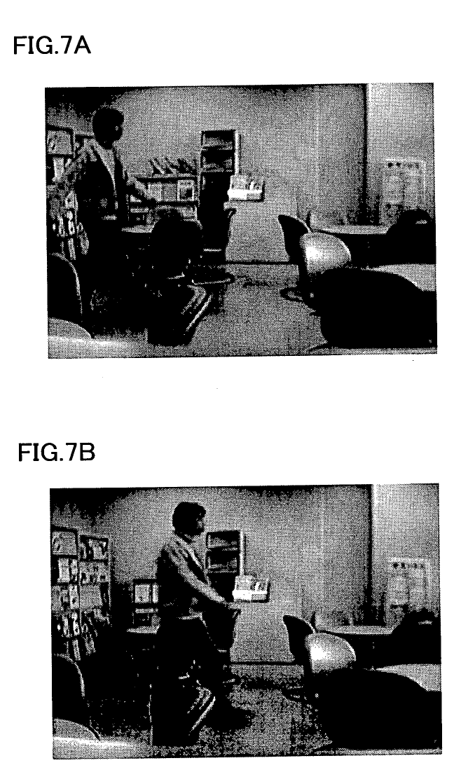

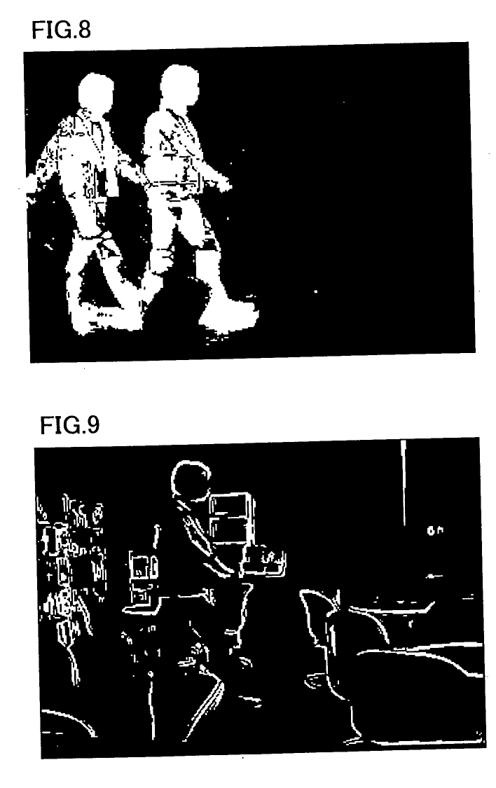

FIGS. 7A and 7B specifically show by way of example an image of time (t−Δt) and an image later by half a second (Δt=half a second), i.e., an image of time t, respectively, as input through camera I/F 107. FIG. 8 shows the two images' motion difference image binarized. The FIG. 8 image corresponds in FIG. 6 to image A. FIG. 9 shows an image obtained by binarizing a spatial difference image obtained by applying the Sobe1 operator to the FIG. 7B image. The FIG. 9 image corresponds in FIG. 6 to image B.

When a human object moves fast, in a motion difference image the object's edge can disadvantageously be detected at two locations, as shown in FIG. 8. Furthermore, in the FIG. 9 spatial difference image obtained by applying Sobe1 operator, the object's edge as well as a large number of edges of a background will disadvantageously be detected.

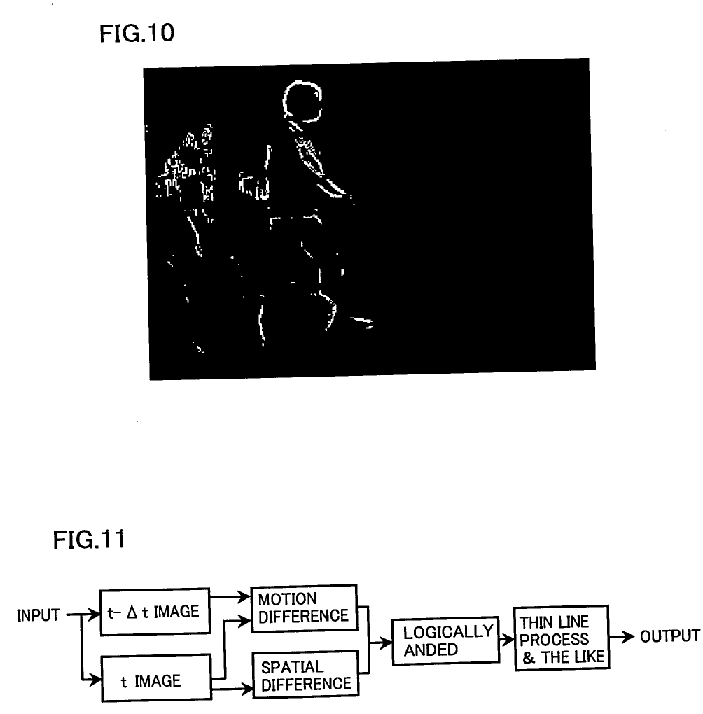

FIG. 10 shows a logically ANDed image obtained by logically ANDing together ANDed the FIG. 8 image and the FIG. 9 image. By obtaining a logically ANDed image from a motion difference image and a spatial difference image, as described above, only a pixel determined to be an edge in both the motion difference image and the spatial difference image is allowed to remain as an edge. This prevents a human object from having two edges detected and also significantly reduces the background's edge.

In the present embodiment the monitoring system allows the above described edge extraction process to be executed to allow a moving object's edge to be alone separated from a background's edge and accurately detected. Furthermore, however fast a single object may move, there is not more than one edge detected obtained from the single object. A moving object's edge can be extracted from a motion image accurately.

Note that as shown in FIG. 11, an edge image obtained through the above described head extraction process that further undergoes a thin line process, a noise removal process through expansion and reduction, and the like may be output to obtain a clearer edge of a moving object.

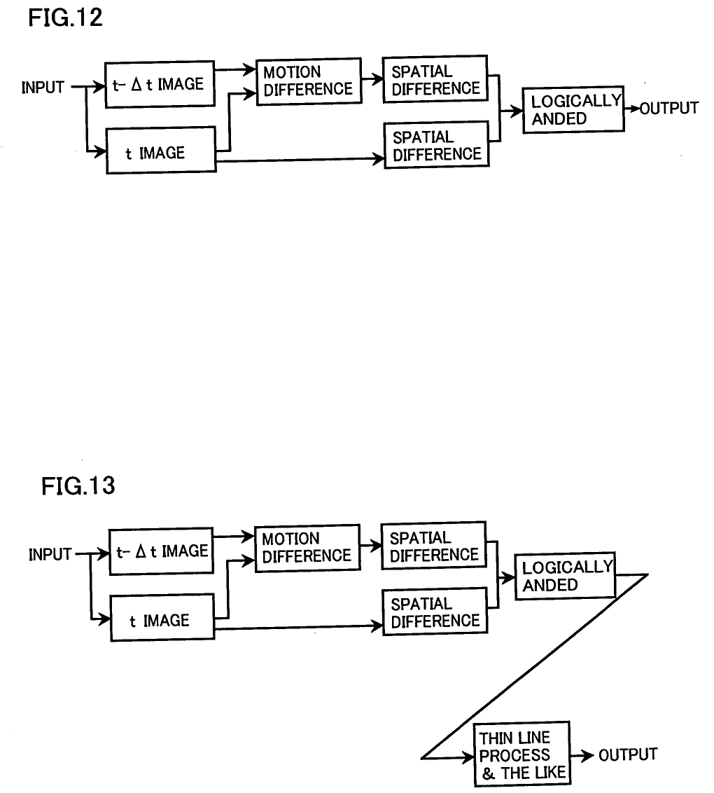

Furthermore, as shown in FIG. 12, a spatial difference image produced by further calculating a spatial difference for a motion difference picture obtained from the image of time (t−Δt) and that of time t, and a spatial difference image produced from one of the images (the image of time t in FIG. 12), may be logically ANDed together to extract an edge. Furthermore, as shown in FIG. 13, an edge image obtained through the above described edge extraction process that further undergoes a thin line process, an expansion process, or a reduction process, or a similar noise removal process may be output to further reduce noise and more accurately detect a moving object's edge.

In the above description, in PC 1 having obtained a motion image from camera 2 the above described edge extraction process is performed. If camera 2 stores a program for effecting the above described edge extraction process and includes a CPU which has the ability to extract an edge, or camera 2 includes an application specific integrated circuit (ASIC) effecting the above described process, camera 2 may effect the edge extraction process.

Furthermore in the above described edge extraction process a motion difference and a spatial difference are calculated to extract an edge. Alternatively, a difference depending on a parameter other than time and space may be calculated to similarly extract an edge. Furthermore, while in the above described edge extraction process an edge is extracted by logically ANDing differential images, an edge may be extracted by logically ORing the differential images.

Furthermore while in the above described edge extraction process two images obtained at times, respectively, different by Δt are used to calculate both a spatial difference and a motion difference, the present invention is not limited thereto. For example, of two images, one image may be a background image, as has been mentioned above, and in that case, the background image may previously be obtained, and the exact background image, the background image's spatial difference image, or both may be stored in HDD 102 or RAM 104. If the background image is stored, one of the background image and an image obtained when the system actually provides monitoring (hereinafter referred to as “the obtained image”) can be used to produce a spatial difference image and from the background image and the obtained image a motion difference image can be produced, and from the spatial difference image and the motion difference image a moving object's edge can be extracted. The background image can be obtained for example immediately after a program for executing an extraction process is started. At predetermined temporal intervals a background image may be updated and obtained.

Furthermore, a previously obtained background image and two images obtained at times, respectively, different by At for a total of three images can be used to obtain a plurality of differential images to extract a moving object's edge. For example, from a background image a spatial difference image may be obtained and from two obtained image a motion difference image may be obtained, and from the spatial and motion difference images a moving object's edge may be extracted.

Furthermore while in the above edge extraction process two images obtained at times, respectively, different by At are used to calculate both a spatial difference and a motion difference to extract an edge, for each of the two images only a spatial difference may be calculated to obtain a differential image and two differential images thus obtained may be subtracted to extract an edge. Furthermore, if only a spatial difference is calculated to extract an edge, one of the two images may be a previously obtained background image.

Furthermore, the above described edge extraction method may be provided in the form of a program. Such a program can be recorded in a flexible disc, a CD-ROM, a ROM, a RAM, a memory card or a similar, computer readable recording medium and provided as a program product. Alternatively it may be recorded in a computer-incorporated hard disc or a similar recording medium and provided. Alternatively it may be download through a network.

The program product provided is installed in a hard disk or a similar program storage and executed. Note that the program product includes the exact program and a recording medium having the program recorded therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An apparatus obtaining an edge image of a moving object, comprising:
an image capturing unit capturing an image of an object, said image capturing unit capturing a first image and a second image at a time different than said first image, said second image having a background identical to that of said first image; and
a controller exerting control to obtain a first differential image based on said first image and a second differential image based on at least one image including said second image and perform an operation on said first and second differential images to produce an edge image of a moving object.

2. The apparatus of claim 1, wherein said first differential image is an image obtained by calculating a spatial difference of said first image and said second differential image is an image obtained by calculating a motion difference of said first and second images.

3. The apparatus of claim 1, wherein said controller binarizes each of said first and second differential images prior to said operation.

4. The apparatus of claim 1, wherein said operation includes an operation logically ANDing together said first and second differential images, or logically ORing said first and second differential images.

5. The apparatus of claim 1, wherein said controller after said operation exerts control to perform a thin line process or a noise removal process to produce said edge image.

6. The apparatus of claim 2, wherein said second differential image is the image obtained by calculating the motion difference of said first and second images and further calculating a spatial difference of said motion difference.

7. A method of obtaining an edge image of a moving object, comprising the steps of:
capturing an image of an object, said image including a first image and a second image having a background identical to that of said first image and captured at a time different than said first image;
obtaining a first differential image based on said first image and a second differential image based on at least one image including said second image; and
performing an operation on said first and second differential images to produce an edge image of a moving object.

8. The method of claim 7, wherein said first differential image is an image obtained by calculating a spatial difference of said first image and said second differential image is an image obtained by calculating a motion difference of said first and second images.

9. The method of claim 7, further comprising the step of binarizing each of said first and second differential images prior to said operation.

10. The method of claim 7, wherein said operation includes an operation logically ANDing together said first and second differential images, or logically ORing said first and second differential images.

11. The method of claim 7, further comprising the step of performing a thin line process or a noise removal process after said operation.

12. The method of claim 8, wherein said second differential image is the image obtained by calculating the motion difference of said first and second images and further calculating a spatial difference of said motion difference.

13. A computer readable program product causing a computer to obtain an edge image or a moving object, the product causing the computer to execute the steps of:
capturing an image of an object, said image including a first image and a second image having a background identical to that of said first image and captured at a time different than said first image;
obtaining a first differential image based on said first image and a second differential image based on at least one image including said second image; and
performing an operation on said first and second differential images to produce an edge image of a moving object.

14. The program product of claim 12, wherein said first differential image is an image obtained by calculating a spatial difference of said first image and said second differential image is an image obtained by calculating a motion difference of said first and second images.

15. The program product of claim 12, further causing said computer to execute prior to said operation the step of binarizing each of said first and second differential images.

16. The program product of claim 12, wherein said operation includes an operation logically ANDing together said first and second differential images, or logically ORing said first and second differential images.

17. The program product of claim 12, further causing said computer to execute after said operation the step of performing a thin line process or a noise removal process.

18. The program product of claim 13, wherein said second differential image is the image obtained by calculating the motion difference of said first and second images and further calculating a spatial difference of said motion difference.
